(19) United States
(12) Patent Application Publication
(10) Pub. No.: US 2023/0274268 A1
(43) Pub. Date: Aug. 31, 2023

(54) SYSTEMS AND METHODS FOR MINTING NON-FUNGIBLE TOKENS AT A POINT OF SALE

(71) Applicant: SALT HOLDINGS, New York, NY (US)

(72) Inventor: Roger Hahn, New York, NY (US)

(73) Assignee: SALT HOLDINGS, NEW YORK, NY (US)

(21) Appl. No.: 17/681,710

(22) Filed: Feb. 25, 2022

(51) Int. Cl. G06Q 20/38; G06Q 20/12; G06Q 50/00; G06Q 20/40; G06Q 20/32

(52) U.S. Cl. CPC G06Q 20/3827; G06Q 20/1235; G06Q 50/01; G06Q 20/4014; G06Q 20/3274

(57) ABSTRACT

Systems and methods are disclosed that generate Non-Fungible Tokens (NFTs) at a point of sale using a QR code and a private key. The systems and methods can also be used to verify the purchase of a ticket to a real-world event such as a concert for display, purchase, or sale in the so-called Metaverse. The systems and methods can be used to verify the source of a credential such as a diploma, degree, or certification of any kind. The systems and methods mint NFTs that can be used to prove the source or authenticity of the real-world product, event, or credential. The requestor of the verification can be a 3^{rd} party such as a social media, ecommerce, or dating platform.

### FIELD

Systems and methods are disclosed that generate non-fungible tokens (NFTs) based on sales of physical items such as an item purchased in a store using a QR code and a private key. The systems and methods can also be used to verify the purchase of a ticket to a real-world event such as a concert for display, purchase, or sale in the so-called Metaverse. The systems and methods can be used to verify the source of a credential such as a diploma, degree, or certification of any kind. The systems and methods mint NFTs that can be used to prove the source or authenticity of the real-world product, event, or credential. The requestor of the verification can be a 3^{rd} party such as a social media, ecommerce, or dating platform.

### BACKGROUND

The source of a good is the touchstone of brand ownership. However, brands owners struggle with controlling the digital form of a physical good. A screenshot or a photo can be shared and distributed in electronic form over the internet. The source of the digital form, e.g., image file, oftentimes cannot be verified as being from a particular source. Importantly, the image file of a brand cannot be easily tracked online for either authorized or unauthorized usage. Brand owners must expend considerable time and effort to track, monitor, and enforce their intellectual property in the digital world using second best options such as monitoring. The problem will only grow as real-world goods are displayed, bought, and sold in the so-called Metaverse. Yet, improper use of proprietary digital works or brand names continues. Similarly, a certification such as a diploma oftentimes must be verified by going to the original issuer. Employers or anyone seeking to verify a credential must confirm authenticity of a diploma or record at the source. A photocopy or a picture is insufficient to prove the veracity and source of a credential.

Blockchains are known as methods of tracking various transactions that provide peer reviewed dislocated proof of the origin of a given token. Non-fungible tokens (NFTs) are commonly used to represent digital art or a sign of ownership. However, existing systems and methods fail to sufficiently link a physical item represented by an NFT to the source of a good or event. For example, a screenshot of an NFT of digital art can be taken and a counterfeit NFT of the same digital image can be made. An image file of a luxury item can be purported to be owned by a user without proof. Currently, there is no mechanism to prove that the NFT is an actual original of a digital file or a digital representation of a physical good or real-world event. Usage and the transfer of a digital representation of a physical item are disconnected from each other. Purchasers, owners, and 3^{rd} parties of specific product brands cannot prove the authenticity of their item without resorting to authentication at the source. Attendees to an event or credentialed persons must also resort to verification at the source. Proving an occurrence or transfer took place, requires querying the source of specific event each time.

Social media platforms cannot verify credentials of a user such as diploma or prior job history. Other platforms such as auction, ecommerce, or online classifieds site cannot verify that a user is the actual owner of a particular item or ticket to an event. Still other platforms cannot verify for other users that a particular user is in the fact the owner of a luxury item such as might be desirable in online wealth-signaling in a photo-sharing application. Even further still, dating platforms cannot verify identity and must rely on users to self-authenticate using email verification, photos of physical IDs, or other similar means. The social media platforms cannot authenticate that a particular item, credential, or even identity of a user is true.

Hence, there is a need for systems and methods that can generate digital non-fungible tokens (NFT) that represent a physical item, event, or credential. The need extends to NFTs that verify or prove the source of a physical item. The need still extends to systems and methods that show the source of a NFT for brand control. The need also includes tracking subsequent sales and transfers of digital item representing a real, tangible product, event, or accreditation. Similarly, there is a need for system and methods to generate digital non-fungible tokens based on specific occurrences or identity. There is further a need for systems and methods that can be used to verify the authenticity of the tokens, and thereby the products, events, occurrences, or identities that the tokens represent.

### SUMMARY OF THE INVENTION

The problem to be solved by the present invention is digital verification of the authenticity of a product, event, occurrence, or identity. The solution is to generate a unique hashed number comprised of a public number and private number associated with a product, event, occurrence, or identity using in part a secret, private number associated with the product, event, occurrence, or identity for later verification.

The first aspect relates to a computing system. The computing system can include an Application Programming Interface (API) callable by a requestor: returning authentication results to the requestor; the authentication results confirming a hash of a public number and a private number for a Non-Fungible Token (NFT), wherein the NFT contains a public number and a hash of the public number and the private number; a memory storing program instructions, the processor coupled to the memory and configured to execute the program instructions for the API, wherein when executed the program instructions cause the processor to retrieve block content from a portion of a blockchain or an indexed database of blockchain data containing the private number wherein the processor confirms the hash of the public number and the private number; and the processor returns the authentication results to the requestor via the API.

In any embodiment, the API can be triggered by a mobile application or a web application.

In any embodiment, the NFT contains metadata indicating a source of a physical good.

In any embodiment, the NFT contains metadata indicating attendance at an event selected from the group of a musical concert, movie, play, or conference.

In any embodiment, the NFT contains metadata indicating a source of a credential such as a driver's license, diploma, degree, or job history.

In any embodiment, the requestor can be a social media platform selected from the group of an auction site, an ecommerce site, a professional or personal network, a photo-sharing application, and a dating platform.

In any embodiment, the indexer can store block data on a public or private database and causes the processor to retrieve block content, block hashes, and block numbers from one or more blocks among a hash-linked chain of blocks on one or more blockchain.

In any embodiment, the public number can be selected from the group of a QR code, a GUID, a brand name, an owner, and wherein the private number is selected from the group of a GUID, a randomly generated number, and a computer-generated number.

In any embodiment, the program instruction can initiate a request to the API wherein the program instructions cause the processor to receive payment selected from the group of a digital token, electronic transfer, and ACH.

The features disclosed as being part of the first aspect can be in the first aspect, either alone or in combination, or follow any arrangement or permutation of any one or more of the described elements. Similarly, any features disclosed as being part of the first aspect can be in a second, third, or fourth aspect described below, either alone or in combination, or follow any arrangement or permutation of any one or more of the described elements.

The second aspect relates to a system. The system can include a smart contract capable of minting a Non-Fungible Token (NFT), comprising metadata reflecting a public number and a hash of the public number and a private number, a scanned product or event code, and an image of the scanned product or representation of the event; a server generating a hashed ID based on the public number and the private number from data obtained from the blockchain or an indexed database; the server callable via an API to confirm that the hash of the public number and private number obtained from the blockchain or indexed database is equivalent to the hash of the public number and private chain stored as metadata on the NFT.

In any embodiment, the private number can be a brand GUID associated with the product or event.

In any embodiment, the private number, the scanned product code, and the image of the product or event can be received by the system from a mobile application.

In any embodiment, the API receives the scanned product code, the image of the product, and a salesperson ID from a user; wherein the API receives the private number from a database based on the salesperson ID.

In any embodiment, the step of indexing includes indexing a hashed number and a transaction hash in a database of an NFT.

In any embodiment, the scanned product code is a QR code or UPC.

In any embodiment, the product is selected from a tangible item, an event, or an accreditation.

In any embodiment, the product is an occurrence, and wherein the image of the product is evidence of the occurrence.

The features disclosed as being part of the second aspect can be in the second aspect, either alone or in combination, or follow any arrangement or permutation of any one or more of the described elements. Similarly, any features disclosed as being part of the second aspect can be in a first, third, or fourth aspect described below, either alone or in combination, or follow any arrangement or permutation of any one or more of the described elements.

The third aspect relates to a method. The method can include receiving, by a system, a transaction hash from a requestor for a Non-Fungible Token (NFT) containing a hashed number, and a public number and a private number from a database for generating a hash of the public number and private number; and returning a response, by the system, confirming if the generated hash of the public number and private number is equivalent to the hashed number of the NFT indicated by the transaction hash.

In any embodiment, the private number is a brand GUID associated with a product, event, or accreditation.

In any embodiment, the private number, a scanned product code, and an image of the product are received by the system from a mobile application, website, or Application Programming Interface (API).

In any embodiment, the mobile application receives the scanned product code, the image of the product, and a salesperson ID from a user; wherein the mobile application, website, or Application Programming Interface (API) receives the GUID from a database based on the salesperson ID.

In any embodiment, the step of indexing includes the hashed public number and private number, and a transaction hash in a database.

In any embodiment, the scanned product code is a QR code or UPC.

In any embodiment, the product is a tangible item, event, or accreditation.

In any embodiment, the product is an occurrence, and wherein the image of the product is evidence of the occurrence.

The features disclosed as being part of the third aspect can be in the third aspect, either alone or in combination, or follow any arrangement or permutation of any one or more of the described elements. Similarly, any features disclosed as being part of the third aspect can be in a first, second, or fourth aspect described below, either alone or in combination, or follow any arrangement or permutation of any one or more of the described elements.

The fourth aspect relates to a method. The method can include the steps of: receiving, by a system, a request for verification of a product, a transaction hash associated with the product, and a scanned product code associated with the product; obtaining from a database a GUID associated with the product based on the transaction hash; generating a hashed ID based on the GUID and the scanned product code; determining whether the generated hashed ID matches a second hashed ID associated with the product in the database; and returning to a user an indication of whether the generated hashed ID matches the second hashed ID associated with the product.

In any embodiment, the step of obtaining a fee from a user includes submitting the request for verification of the product.

In any embodiment, the fee is a digital token, and further comprising the step of recording a transaction associated with the token in a blockchain.

In any embodiment, the GUID is a brand GUID associated with the product.

In any embodiment, the scanned product code is a QR code or UPC.

In any embodiment, the product is a tangible item.

In any embodiment, the product is an occurrence, and wherein the image of the product is evidence of the occurrence.

The features disclosed as being part of the fourth aspect can be in the fourth aspect, either alone or in combination, or follow any arrangement or permutation of any one or more of the described elements. Similarly, any features disclosed as being part of the fourth aspect can be in a first, second, or third aspect described below, either alone or in combination, or follow any arrangement or permutation of any one or more of the described elements.

### BRIEF DESCRIPTION OF THE DRAWINGS

FIG. 1 is a block diagram of the use of a system to generate an NFT associated with the sale of an item.

FIG. 2 is a detailed block diagram of the use of a system to generate an NFT associated with the sale of an item and to verify the authenticity of the item at a later time.

FIG. 3 is a flowchart showing one embodiment of a method for minting a new NFT.

FIG. 4 is a flow chart showing a method for authenticating the NFT.

### DETAILED DESCRIPTION

Unless defined otherwise, all technical and scientific terms used have the same meaning as commonly understood by one of ordinary skill in the art.

The articles “a” and “an” are used to refer to one to over one (i.e., to at least one) of the grammatical object of the article. For example, “an element” means one element or over one element.

An “Application Programming Interface” is intended to be understood in the broadest sense and can include any set of definitions and protocols for building and integrating application software. The definitions and protocols provide a standardized software interface that can be consumed by a user. The API is typically HTTP and REST and can be accessed by mobile applications, web applications, and other APIs.

An “auction site” is an application, mobile app, or website, where the price of a product or service is determined by a winning bid.

The term “authentication results” refers to any data authenticating or providing data or information to a requestor or user. In one non-limiting embodiment, the authentication results can be a Boolean on whether a first hashed value is equivalent to a second hashed value.

A “blockchain” is a system by which a record of transactions is maintained across several computers.

A “brand owner” refers to a source of a good, service, or product. Typically, brand owners are concerned with maintaining goodwill and controlling messaging about their goods and services.

A “brand GUID” is an alphanumeric identification number associated with a specific brand of products.

The term “comprising” includes, but is not limited to, whatever follows the word “comprising.” Use of the term indicates the listed elements are required or mandatory but that other elements are optional and may be present.

The term “consisting of” includes and is limited to whatever follows the phrase “consisting of.” The phrase indicates the limited elements are required or mandatory and that no other elements may be present.

The term “consisting essentially of” includes whatever follows the term “consisting essentially of” and additional elements, structures, acts, or features that do not affect the basic operation of the apparatus, structure or method described.

A “database” is an organized repository of digital information.

A “dating site” is an application, mobile app, or website that lets users to find and introduce themselves to potential connections over the Internet.

The term “determining” or to “determine” refers to a system or application ascertaining a state of any given variables.

A “ecommerce site” is an application, mobile app, or website that allows people to buy and sell physical goods, services, and digital products over the internet rather than at a brick-and-mortar location.

The term “evidence of an occurrence” is any information that tends to show that a specific occurrence happened.

The term “fee” refers to payment for a service or product. The fee can be in any form and is not limited to currency.

The terms “first,” “second,” and “third,” and the like, refer to separate and distinct features. For example, one or more sections can be identified as a ‘first computer,” “second computer,” and “third computer.” Alternatively, one or more computers can be identified as a ‘first computer,” “second computer,” and “third computer.” The terms “first,” “second,” and “third,” and the like are not meant to refer to a specific order of events or arrangements of computers unless otherwise stated.

The terms “generating,” to “generate,” “generated,” and the like, mean to create a specified item that can be a tangible item or digital information.

A “GUID” or “global unique identifier” is an alphanumeric identification number associated with a specific person, business, even, accreditation, or brand.

The term “hash,” “hashing,” “hashing function,” and the like refers to a computationally efficient and deterministic processes whereby every time a certain data is inputted, the hash will produce the same output. Moreover, the hash or hashing function is pre-image resistant, meaning that the function cannot reveal any information about the input in the output. Common hashing, but non-limiting list of hashing functions include SHA-256, Keccak, SHA 512, Elliptic Curve Cryptography, BLAKE2, and others known to those of skill in the art.

The term “hashed ID” refers to an alphanumeric identifier given to a transaction.

The term “image of a product,” or “product image” refers to a digital image of a specific item or occurrence.

The term “indexing” or to “index” refers to the process of saving information in a database, typically from a blockchain, and associating the information with one or more identifiers or other information to enable the saved information to be quickly and efficiently accessed and/or retrieved.

The term “indication” means any type of signal or information.

The term “match” refers to two or more pieces of digital information having identical identifiers.

The term “memory” refers to a non-transitory machine-readable storage medium or a non-transitory computer readable storage medium or a non-transitory machine-accessible storage medium on which is stored one or more sets of instructions (e.g., software) embodying any one or more of the methodologies or functions described herein.

The term “mobile application” refers to an application running on a mobile device or computer.

A “non-fungible token” or “NFT” is a cryptographic asset, cryptographic token, or digital ledger object that is recorded on a blockchain. NFTs are indivisible, and not mutually interchangeable. A given NFT has unique metadata, attributes, or characteristics, such as permanent, unalterable metadata that describes or defines authenticity. NFTs are unique and non-subdividable. They may function as unique certificates of authenticity, making them suitable for proof of ownership, for example, in authenticating ownership of a physical item so long as linked to the physical item; attendance at an event so long as linked to the event; proof of credentials so long as long as linked to an accreditation service; proof of identity so long as linked to the identity verifier; and proof of the source of goods so long as linked to the manufacturer or point of sale. Commonly, the NFT can be a smart contract as defined by Ethereum Improvement Proposals (EIPs), ERC721 or ERC1155 standards. Commonly, ERC721 or ERC1155 standards follow a set of interfaces, contracts, and utilities published by OpenZeppelin (https://docs.openzeppelin.com/).

The term “occurrence” refers to any type of event or information about the event.

A “photo-sharing site” is an application, mobile app, or website used to store and share photos. Users can upload their pictures to the system, which are stored on the server and made available to other users either publicly or privately. Importantly, photo-sharing sites can be integral to ecommerce, wealth signaling, and other socially relevant functions.

A “private number” is a number or alphanumeric of any length or type that is intended to be kept secret and cannot be viewed by the public.

The term “processor” refers to a computing component having any suitable execution hardware, software, or logic which can serve to operate any computer operated function described herein.

A “public number” is a number or alphanumeric of any length or type that is publicly viewable.

The term “product” refers to any tangible or intangible item, or any occurrence.

A “QR code” is a machine-readable code having black and white squares for storing information.

The term “receiving” or to “receive” means to obtain electronic information or data from any source by any method known in the art.

The term “requestor” refers to any user, computer program, data call, or POST/GET request obtaining information or data.

The term “request for verification” refers to a user using an application to have a system determine the authenticity of a product or occurrence.

A “salesperson ID” refers to an alphanumeric identifier associated with a specific person authorized to sell specific products.

The term “saving” or to “save” refers to recording digital information.

The term “scanned product code” refers to a QR code, UPC, or other code associated with a product being sold or made.

A “social media platform” refers to an application, mobile application, or website through which users are able to create and share content and find and connect with other users; and connect with other users.

The term “tangible” refers to an actual physical item.

A “token” is a fungible or non-fungible representation of an item or fact.

A “transaction hash” is a unique alphanumeric identifier associated with a specific transaction or occurrence.

A “UPC” is a machine-readable code of lines or rectangles for storing information.

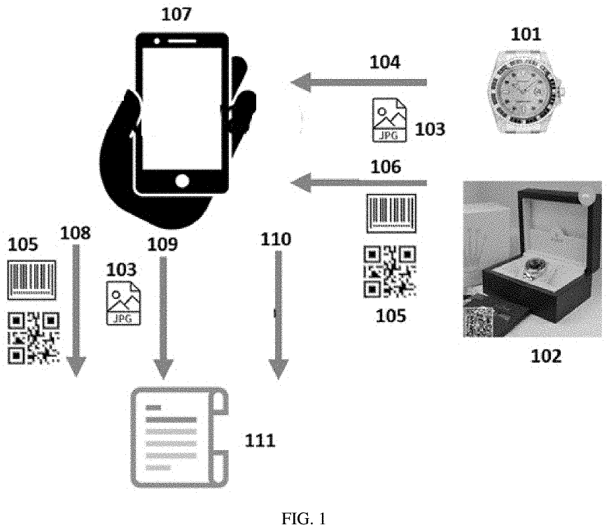

FIG. 1 is a schematic block diagram of a non-limiting embodiment showing the use of a mobile application to generate a non-fungible token (NFT) based on a transaction of a real, tangible product. In FIG. 1, the product sold is a watch 101. However, one of skill in the art will understand that the same systems and methods can be used to create NFTs based on any type of product. Moreover, the mobile application can connect to API, or the mobile app can be replaced by a website. In FIG. 1, a user, such a salesperson, can take a picture of the watch 101 image file 103. In certain embodiments, the image file can be a jpeg file, or any other file type known in the art and be pre-taken. The image can also be high quality art or renderings of a particular product. For example, a brand may have an renderings of the brand's entire product lineup stored, so that a photo of the product does not need to be taken. The image file 103 can be obtained using mobile device 107, as represented by arrow 104. The user also scans a QR code or UPC 105 from the packaging 102 to obtain a product code 105 associated with the watch 101 or any other product, as represented by arrow 106. The QR code can serve as the public number that is hashed with a private number to create a unique digital signature.

An application running on mobile device 107 can transmit the QR code or UPC 105, the image file 103, and a unique hashed ID to a smart contract 111 to generate the NFT, as represented by arrow 108, arrow 109, and arrow 110, respectively. The process by which the unique hashed ID is generated is described herein. The information can then be stored on a blockchain, which serves as proof showing that source of the product as being the original creator of the NFT. Although shown as an application running on a mobile device 107 in FIG. 1, one of skill in the art will understand that the system can use any type of computing device and is not limited to smartphones or other mobile devices. Alternatively, instead of directed to a product, the image file 103 can be for an event ticket, a diploma, license or certificate of any type, or a government issued ID. The related QR code or any other suitable number that is publicly available can be used has the public number used in the hash of the private number and the public number.

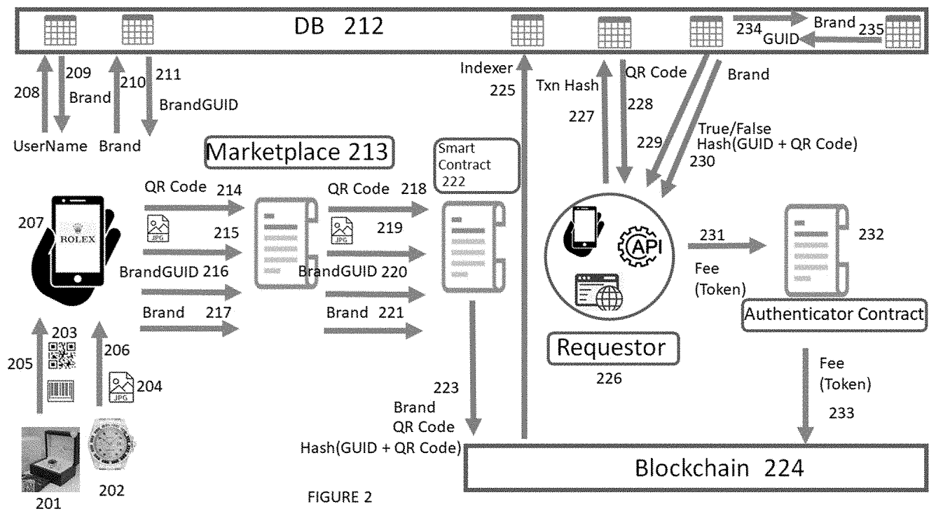

FIG. 2 shows a more detailed system for generating and verifying NFTs based on real world objects, events, occurrences, or accreditations. As described with respect to FIG. 1, a user selling a product such as watch 201 can take a picture of the watch 201 to generate an image file 204 which is then accessed by an application running on mobile device 207 as represented by arrow 206. Any public number such as a QR code or UPC 203 from the product packaging 202 can also be scanned by the mobile device 207 as illustrated by arrow 205. Optionally, the public number can be pre-stored in a database that can be retrieved by the mobile device 207.

In certain embodiments, the image file 204 can be a pre-made rendering or digital art rather than a photograph taken using the mobile device 207. For example, a salesperson of a business that sells watches may select a premade image of the specific brand and model of watch being sold from a menu or from the memory of the mobile device 207.

The salesperson selling the watch 201 can log into the application using a unique salesperson ID. Alternatively, the application can ask for a salesperson ID at any point during the process. The salesperson ID is checked a database 212, as represented by arrow 208.

The system verifies that the salesperson ID matches a brand of product being sold in the database 212, and returns the brand or brands associated with the salesperson as represented by arrow 209. After verifying that the brand of product being sold is associated with the salesperson ID, the system checks the specific brand in the database 212, as represented by arrow 210 to obtain a global unique identifier (GUID) associated with the brand. The system receives the brand GUID from the database 212, as represented by arrow 211. This brand GUID is unique to the specific brand of product being sold and is not accessible by the public.

The mobile application the transmits to a marketplace 213 information necessary to generate an NFT associated with the watch 201 being sold. The system sends the QR code 203, as represented by arrow 214, the image file 204 as represented by arrow 215, the brand GUID as represented by arrow 216, and the brand of the product as represented by arrow 217. This information is used to generate the new NFT.

From the marketplace smart contract 213, an NFT smart contract 222 can be generated using the information, including the QR code 203, as represented by arrow 218, the image file 204 as represented by arrow 219, the brand GUID as represented by arrow 220, and the brand of the product as represented by arrow 221. The smart contract 222 can create a transaction hash for the sale of the watch and save the transaction hash on a blockchain 224 as represented by arrow 223. The smart contract 222 can include the brand of the product being sold, the QR code, and a unique hashed ID that can be used to verify authenticity. Alternatively, the NFT can contain metadata indicating attendance at an event selected from the group of a musical concert, movie, play, or conference. The NFT can also contain metadata indicating a source of a credential such as a driver's license, diploma, degree, or job history.

The hashed ID uses the QR code, which can be obtained by anyone with the product, as well as the brand GUID, which is secret. A random number generator or any other method known in the art for generating a hashed ID from the two pieces of information is used to generate the hashed ID. The hashed ID, the brand, and the QR code are saved in the smart contract. Because the brand GUID is not known to the public, the public cannot generate a hashed ID that will match for the specific product being sold. In other words, the QR code 203 can represent the public number, or public key, and the brand GUID can represent the private number, or private key. The public key and private key can be combined in any way such as by concatenating both numbers, and the resulting number, hashed. The hashed number can then be stored on the blockchain.

In certain embodiments, the system can index the information saved in the blockchain in the database 212 as shown by indexer arrow 225. Although it is possible to obtain all the necessary information for authentication from the blockchain 224, the system is easier and faster when an indexed database is used.

After the NFT is minted based on the initial transaction, any other user can request verification of the authenticity of the NFT or the product the NFT represents. A requester 226, using a mobile app, API, or any other method can submit a request for verification. The requester 226 can be a social media platform. The requester 226 can be an auction site, an ecommerce site, a professional or personal network, a photo-sharing application, or a dating platform. The requester 226 can submit a transaction hash showing the location of the NFT to the database 212 as represented by arrow 227. The system determines the brand of product based on the information in the smart contract associated with the transaction hash. Using the same database 212 as to generate the initial smart contract 222, the system can obtain the correct brand GUID, as represented by arrow 234 and 235. The system then re-generates the unique hashed ID based on the QR code and brand GUID and checks this second hashed ID against the initially created hashed ID. The requester 226 receives back the QR code as represented by arrow 228, the brand of the product as represented by arrow 229, and an indication of whether the generated hashed ID matches the initially created hashed ID associated with the product as represented by arrow 230. In certain embodiments, the indication can be a simple true or false with respect to the authenticity of the product.

The requester 226, before making a request or before receiving the results of the verification can be required to pay a fee. In certain embodiments, the fee can be in the form of a token. Alternatively, the fee can be paid using credit or debit cards or any other type of transaction. When the fee is paid using a token, the system can transmit the information to an authenticator smart contract 232 as represented by arrow 231. The authenticator smart contract 232 is then recorded in a blockchain 224 as represented by arrow 233.

Although shown as a single database structure 212 in FIG. 2, one of skill in the art will understand that any of the information can be kept on any number of separate databases on a single or different servers. For example, the salesperson and authenticator application, which require the use of the brand GUID can access one database that has the brand GUID, while the indexer interacts with a completely separate database.

Although FIG. 2 is described with respect to the sale and authentication of a specific tangible item, namely watch 201, the same system can be used for verification of a non-tangible item, such as the occurrence of a specific event. For example, if it may be desired or necessary to prove attendance at an event, the same system can be used. The QR code can be obtained from a ticket to a concert or sporting event or can be provided by the host of any event. The user generating the NFT can include evidence of the occurrence, such as an image of the event as it happens, or their attendance at the event. The user can have their own GUID, which can be used in the same manner as the brand GUID described with respect to FIG. 2. Later, the same authentication system can be used to verify the occurrence of the event or a specific person's attendance. One of skill in the art will understand that any type of tangible or intangible product or occurrences can use the same system.

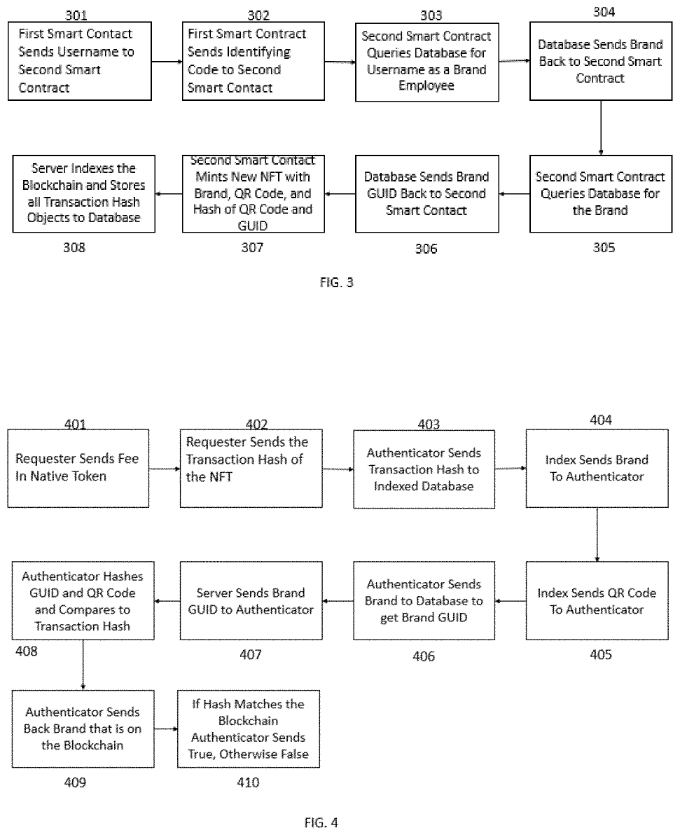

FIG. 3 is a flowchart showing one embodiment of a method for minting a new NFT. In step 301, a first smart contact, such as Marketplace.sol sends the user ID of the salesperson to a second smart contract, such as NFT.sol. In step 302, the first smart contact sends an identifying code for the product to the second smart contract. As described, the identifying code can be the QR code or UPC. In step 303, the second smart contact queries a database for the salesperson ID. The database sends the brand associated with the salesperson ID back to the second smart contract in step 304.

After receiving the brand from the database, the second smart contract can query the database for the brand GUID in step 305. The brand GUID is returned to the second smart contract in step 306. With the QR code and brand GUID, the second smart contract can mint a new NFT having the brand, QR code, and a hash of the QR code and brand GUID in step 307. As described, a random number generator or any other method known in the art can be used for generating a hashed ID from the QR code and brand GUID. In step 308, a server can index the blockchain, storing all of the transaction hash objects to a database.

FIG. 4 is a flow chart showing a method for authenticating the NFT. In step 401, the requestor pays a fee in a native token. In step 402, the requestor sends the transaction hash of the NFT. One of skill in the art will understand that the order of steps 401 and 402 can be changed. Payment in the form of a native token can be required from the requestor at any point during the process.

After receiving the fee and the transaction hash, the authenticator application sends the transaction hash to an indexed database in step 403. As described, using an indexed database may be significantly easier than reading information directly from the blockchain. However, in certain embodiments, the authenticator can read the information directly from the blockchain.

In step 404, the index sends to the authenticator the brand associated with the NFT. In step 405, the index sends the QR code associated with the NFT. Although described as separate steps, one of skill in the art will understand that the data can be received in a single step or in any order. The authenticator next sends the brand to a database to obtain the brand GUID in step 406. The server hosting the brand database returns the brand GUID to the authenticator in step 407.

Using the brand GUID and the QR code, the authenticator regenerates the transaction hash in step 408 using the same method as used in originally creating the transaction hash as described with respect to FIG. 3. In step 409, the authenticator sends back to the requestor the brand that is listed on the blockchain. In step 410, the authenticator sends an indication of authenticity of the NFT. If the hash generated by the authenticator matches the hash provided on the blockchain, the authenticator sends back an indication of true. If the hashes do not match, the authenticator sends back an indication of false.

One skilled in the art will understand that various combinations and/or modifications and variations can be made in the described systems and methods depending upon the specific needs for operation. Various aspects disclosed herein may be combined in different combinations than the combinations specifically presented in the description and accompanying drawings. Moreover, features illustrated or described as being part of an aspect of the disclosure may be used in the aspect of the disclosure, either alone or in combination, or follow a preferred arrangement of one or more of the described elements. Depending on the example, certain acts or events of any of the processes or methods described herein may be performed in a different sequence, may be added, merged, or left out altogether (e.g., certain described acts or events may not be necessary to carry out the techniques). In addition, while certain aspects of this disclosure are described as performed by a single module or unit for purposes of clarity, the techniques of this disclosure may be performed by a combination of units or modules associated with, for example, a device.

What is claimed is:

1. A computing system, comprising:
an Application Programming Interface (API) callable by a requestor: returning authentication results to the requestor; the authentication results confirming a hash of a public number and a private number for a Non-Fungible Token (NFT), wherein the NFT contains a public number and a hash of the public number and the private number;
a memory storing program instructions, the processor coupled to the memory and configured to execute the program instructions for the API, wherein when executed the program instructions cause the processor to retrieve block content from a portion of a blockchain or an indexed database of blockchain data containing the private number wherein the processor confirms the hash of the public number and the private number; and
the processor returns the authentication results to the requestor via the API.

2. The computing system of claim 1, wherein the API is triggered by a mobile application or a web application.

3. The computing system of claim 1, wherein the NFT contains metadata indicating a source of a physical good.

4. The computing system of claim 1, wherein the NFT contains metadata indicating attendance at an event selected from the group of a musical concert, movie, play, or conference.

5. The computing system of claim 1, wherein the NFT contains metadata indicating a source of a credential such as a driver's license, diploma, degree, or job history.

6. The computing system of claim 1, wherein the requestor is a social media platform selected from the group of an auction site, an ecommerce site, a professional or personal network, a photo-sharing application, and a dating platform.

7. The computing system of claim 1, wherein the indexer stores block data on a public or private database and causes the processor to retrieve block content, block hashes, and block numbers from one or more blocks among a hash-linked chain of blocks on one or more blockchain.

8. The computing system of claim 1, wherein the public number is selected from the group of a QR code, a GUID, a brand name, an owner, and wherein the private number is selected from the group of a GUID, a randomly generated number, and a computer-generated number.

9. The computing system of claim 1, further comprising a program instruction to initiate a request to the API wherein the program instructions cause the processor to receive payment selected from the group of a digital token, electronic transfer, and ACH.

10. A system, comprising:
a smart contract capable of minting a Non-Fungible Token (NFT), comprising metadata reflecting a public number and a hash of the public number and a private number, a scanned product or event code, and an image of the scanned product or representation of the event;
a server generating a hashed ID based on the public number and the private number from data obtained from the blockchain or an indexed database;
the server callable via an API to confirm that the hash of the public number and private number obtained from the blockchain or indexed database is equivalent to the hash of the public number and private chain stored as metadata on the NFT.

11. The system of claim 10; wherein the private number is a brand GUID associated with the product or event.

12. The system of claim 10; wherein the private number, the scanned product code, and the image of the product or event are received by the system from a mobile application.

13. The system of claim 10, wherein the API receives the scanned product code, the image of the product, and a salesperson ID from a user; wherein the API receives the private number from a database based on the salesperson ID.

14. The system of claim 10; further comprising the step of indexing the hashed ID and a transaction hash in a database.

15. The system of claim 10; wherein the scanned product code is a QR code or UPC.

16. The system of claim 10; wherein the product is selected from a tangible item, an event, or an accreditation.

17. The system of claim 10; wherein the product is an occurrence, and wherein the image of the product is evidence of the occurrence.

18. A method, comprising:
receiving, by a system, a transaction hash from a requestor for a Non-Fungible Token (NFT) containing a hashed number, and a public number and a private number from a database for generating a hash of the public number and private number; and
returning a response, by the system, confirming if the generated hash of the public number and private number is equivalent to the hashed number of the NFT indicated by the transaction hash.

19. The method of claim 18; wherein the private number is a brand GUID associated with a product, event, or accreditation.

20. The method of claim 18; wherein the private number, a scanned product code, and an image of the product are received by the system from a mobile application, website, or Application Programming Interface (API).

21. The method of claim 20, wherein the mobile application receives the scanned product code, the image of the product, and a salesperson ID from a user; wherein the mobile application, website, or Application Programming Interface (API) receives the GUID from a database based on the salesperson ID.

22. The method of claim 18; further comprising the step of indexing the hashed public number and private number, and a transaction hash in a database.

23. The method of claim 18; wherein the scanned product code is a QR code or UPC.

24. The method of claim 18; wherein the product is a tangible item, event, or accreditation.

25. The method of claim 18; wherein the product is an occurrence, and wherein the image of the product is evidence of the occurrence.

26. A method, comprising the steps of:
receiving, by a system, a request for verification of a product, a transaction hash associated with the product, and a scanned product code associated with the product;
obtaining from a database a GUID associated with the product based on the transaction hash;
generating a hashed ID based on the GUID and the scanned product code;
determining whether the generated hashed ID matches a second hashed ID associated with the product in the database; and
returning to a user an indication of whether the generated hashed ID matches the second hashed ID associated with the product.

27. The method of claim 26, further comprising the step of obtaining a fee from a user submitting the request for verification of the product.

28. The method of claim 26, wherein the fee is a token, and further comprising the step of recording a transaction associated with the token in a blockchain.

29. The method of claim 26; wherein the GUID is a brand GUID associated with the product.

30. The method of claim 26; wherein the scanned product code is a QR code or UPC.
